(19) United States
(12) Patent Application Publication
(10) Pub. No.: US 2004/0125947 A1
(43) Pub. Date: Jul. 1, 2004

(54) Method and apparatus to deploy a mini-touchpad on a cellular phone

(76) Inventors: Michael Charlier, Palatine, IL (US); Kenneth Paitl, East Dundee, IL (US); Paul Steuer, Hawthorn Woods, IL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/331,605

(22) Filed: Dec. 30, 2002

(51) Int. Cl. H04M 1/00; H04M 9/00

(52) U.S. Cl. 379/433.07

(57) ABSTRACT

A wireless communication device 100 including a first end 104 and a second end 106, a display 108 positioned adjacent to the first end 104 and a keypad 120 positioned adjacent to the second end 106. The wireless communications device further includes a receptacle 128 positioned adjacent to the numerical keypad 120 and a keyless input device 102 installable within the receptacle. The keyless input device 102 is postponable and may includes a graphical message.

### TECHNICAL FIELD

The technology generally relates to wireless communication devices and more specifically to wireless communication devices adapted to include a postponable keyless input device.

### BACKGROUND

Wireless communication devices, such as cellular phones and personal digital assistants (PDA) commonly integrate date books, contact lists and email functionality into a single device. Personal digital assistants provide the user with easy access to stored information using either a thumb-board or an integrated touchscreen. Thumb-boards are miniature QWERTY keyboards designed to facilitate data entry by a user with only their thumbs. Touchscreens typically include a liquid crystal display (LCD) coated with a pressure sensitive film, contact with the pressure sensitive film causes a change in an electric field running through the film which can be translated into a position on the display. Devices including a touchscreen and handwriting recognition software, such as JOT® and Graffiti®, allow a user to quickly and efficiently input information into the PDA by writing directly onto the pressure sensitive film and screen. Information may also be inputted by selecting the letters, numbers etc. displayed on a virtual keyboard. Personal digital assistants designed to integrate a thumb-board and/or touchscreen are constrained by the size requirements of each input device. For example, a thumb-board is sized to allow a user to select individual keys using the blunt tip of their thumb, and a touchscreen is sized to simultaneously provide a comfortable writing surface and display information. This size requirement is a common disadvantage of both input methods which reduces the portability and convenience of the devices incorporating them.

Cellular telephones often provide much of the same functionality as personal digital assistants, described above, while further including the flexibility of a cellular telephone. Moreover, these devices are typically designed with a small form factor conducive to handheld, portable usage. Two typical designs for a cellular telephone are one-piece (“candy bar”) designs and two-piece (“clam shell”) designs.

Wireless communication devices configured as a two-piece “clam-shell” design generally include similar functions and capabilities as the one-piece designs. The two-piece design includes a first and second body portions hingeably attached and pivotable between an open and a closed position. The open position exposes a first and a second interior surface including a display positioned on the first surface and a keypad positioned on the second surface. The two-piece design typically provides for a smaller overall package, while increasing the complexity, and therefore the expense, of the device.

It will be readily apparent from these designs that a change in the relative sizes of the body, the display, and the keypad necessarily dictates a change in the size of at least one of the remaining features. For example, to increase the display size of a wireless communication device, the size of the keypad must be reduced or the overall device size must be increased. The limited amount of available space presents a difficult design challenge when new features and/or functions are incorporated into the devices.

The proliferation of new technologies such as wireless web browsing and short messaging service (SMS) are increasing the level of interaction between the user and the device. The increased interaction has resulted in a demand for a more flexible manner of inputting information than those described above. For example, an existing SMS enabled cellular phone requires the user to compose a message using a standard keypad and multiple keystrokes for each letter entered. For example, to input the letter “f” using a standard keypad, may require the three (3) key be depressed four (4) times, 3-d-e-f. Proprietary text entry systems, such as the iTAP® predictive keypad entry software, have been developed in an attempt to simplify the text entry via standard keypads but they still require multiple keystrokes per entry. It is therefore desirable to have a data entry system that would address the challenges described above.

### BRIEF DESCRIPTION OF THE DRAWINGS

FIG. 1 illustrates a prior art one-piece wireless communication device;

FIG. 2 illustrates an embodiment of a wireless communication device adapted to receive a keyless input device;

FIG. 3 illustrates an embodiment of the keyless input device;

FIG. 4 illustrates a cross-sectional view of an embodiment of the keyless input device taken along the section line A-A;

FIG. 5 illustrates a cross-sectional view of an alternate embodiment of the keyless input device taken along the section line A-A;

FIG. 6 illustrates a cross-sectional view of an embodiment of the touchpad taken along the section line A-A;

FIG. 7 illustrates a cross-sectional view of an alternate embodiment of the touchpad taken along the section line A-A;

FIG. 8 illustrates an embodiment of the keyless input device;

FIG. 9 illustrates an embodiment of the keyless input device;

FIG. 10 further illustrates an embodiment of the keyless input device;

FIG. 11 illustrates an embodiment of the wireless communication device adapted to receive the keyless input device;

FIG. 12 illustrates an embodiment of a two-piece wireless communication device adapted to receive the keyless input device; and

FIG. 13 illustrates an embodiment of the keyless input device.

### DETAILED DESCRIPTION

The keyless input device constructed in accordance with a preferred embodiment includes a touchpad and may include at least two dome switches. The dome switches adapted to support the touchpad, and provide a navigation pivot for the user. The keyless input device is further adapted for integration into the space typically reserved for the badge, nameplate, or even a navigation key. Moreover, the keyless input device constructed in accordance with a preferred embodiment may be installed by the reseller before a retail sale to the consumer. The keyless input device may be customized with any desired graphical message, logo, or other printed information.

The touchpad may be a semi-resistive or a capacitive touchpad, thereby allowing text input with a stylus, the tip of a human finger or in any other applicable manner. The keyless input device may communicate and cooperate with a contextual software routine to select and deselect the keyless input device based on the displayed screens. In other words, the processor may disable the keyless input device when text entry is not available on one of the displayed screens while simultaneously allowing input via the dome switches and toggling for navigational purposes.

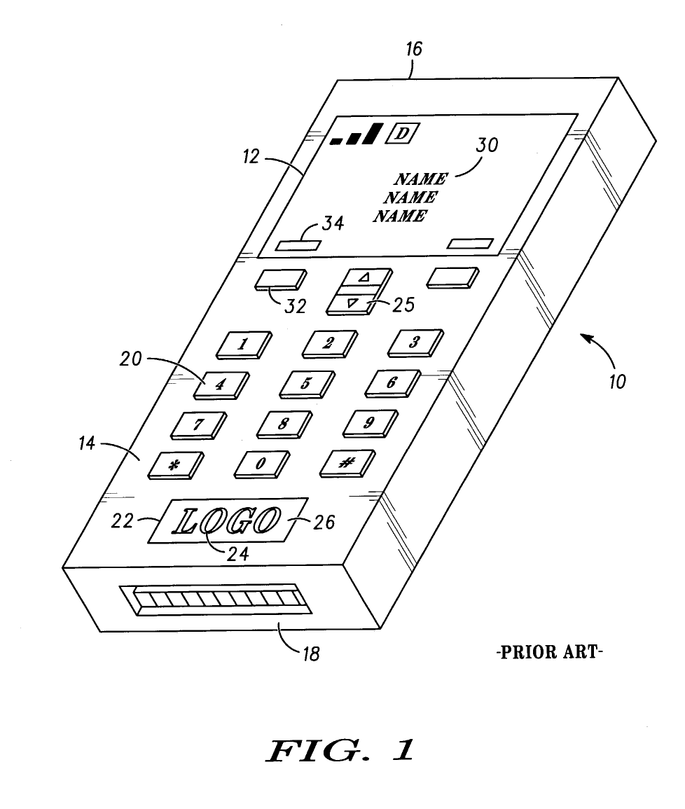

FIG. 1. illustrates a prior art one-piece wireless communication device including a body 10, a display 12 and a keypad 14. The body 10 supporting the display 12 at a first end 16, and the keypad 14 at a second end 18. The keypad 14 including a plurality of depressible keys 20 positioned adjacent to the display 12 and proximate to the second end 18. The keys 20 include twelve raised buttons, arranged in a standard Bell format, to facilitate tactile or touch dialing. The body 10 further includes a postponable installable badge 22 designed to allow resellers to install a badge, name plate or sticker, including a logo 24, name 26 or other graphical message, to identify the device as the reseller's product. The body 10 may further include a navigation key 28 for manipulating information 30 presented on the display 12. A plurality of configurable keys 32 may be incorporated to provide access to a plurality software functions 34 corresponding to the information 30 presented on the display 12.

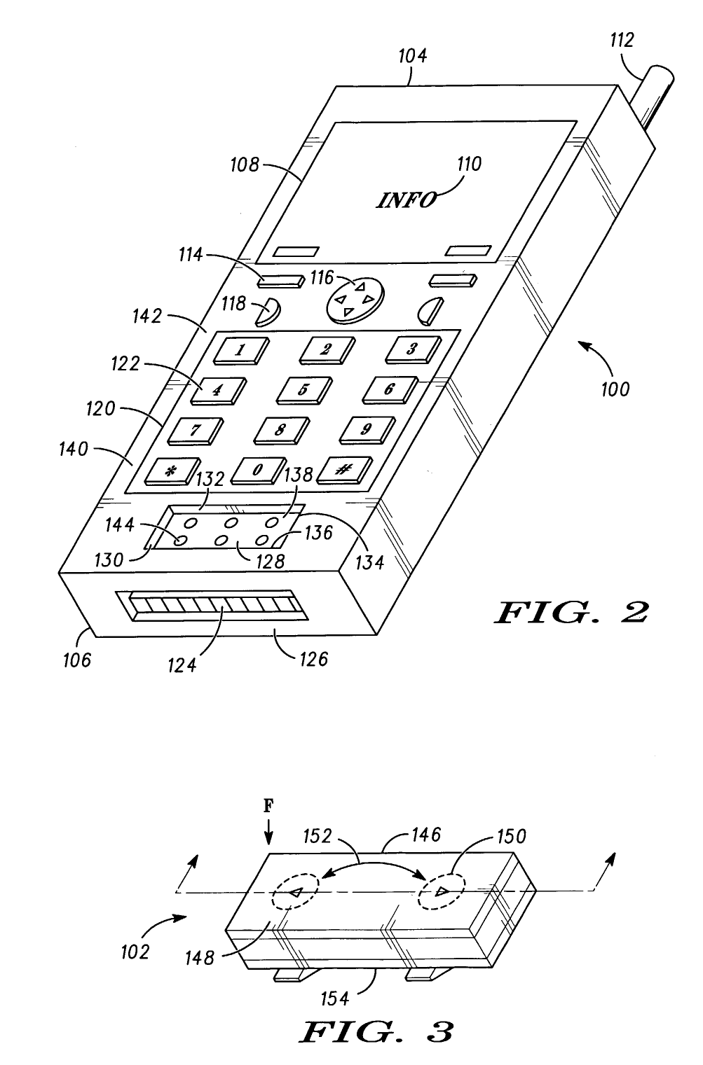

FIG. 2. illustrates a wireless communication device 100 adapted to receive a keyless input device 102, such as the exemplary device shown in FIG. 3. The wireless communication device 100 is a one-piece design having a first end 104 and a second end 106. A display 108, positioned adjacent to the first end 104, is adapted to present information 110 to the user. The term “information”, as used herein, is a general term relating to functions native to the device operating system (i.e. a phone book, a calendar, a calculator, and other phone settings) and data received through a wireless network such as electronic mail, internet-based content, and SMS text messages. The first end 104 or second end 106 may further be adapted to store a stylus 112.

The device 100 further includes configurable keys 114, a navigation key 116 and fixed-function keys 118. The configurable keys 114 cooperate with contextual software or the device operating system to present the user with navigation and selection options corresponding to the information 110 presented on the display 108. The navigation key 116 may be designed in a number of ways including: a circular four-position pivot, a two-position rectangular pivot, a roller and/or a joystick. The navigation key 116 provides a convenient method of manipulating information presented on the display 108. The fixed-function keys 118 are generally used to control function associated with the basic operation of the device 100, such as initiating a telephone call or ending a telephone call.

A keypad 120 including a plurality of keys 122 is positioned proximate to the second end 106. The keypad is arranged to facilitate inputting numeric information, such as telephone numbers, into the device 100. The keypad 120 may be arranged in standard Bell format (i.e. a 3×4 rectangular pattern) or in any other manner that facilitates information entry.

The second end 106 further includes a connector 124 positioned on an end face 126 and a receptacle 128 positioned adjacent to the keypad 120 and the end face 126. The receptacle 128 occupies the space traditionally reserved for the postponable installable badge 22 (see FIG. 1). The receptacle 128 includes a plurality of walls 130-136 and a bottom 138 cooperating to form a pocket 140 relative to a face 142 of the device 100. The receptacle 128 further includes a plurality of connectors 144 providing power and communications between the postponable keyless input device 102 and a processor (not shown) operating within the device 100.

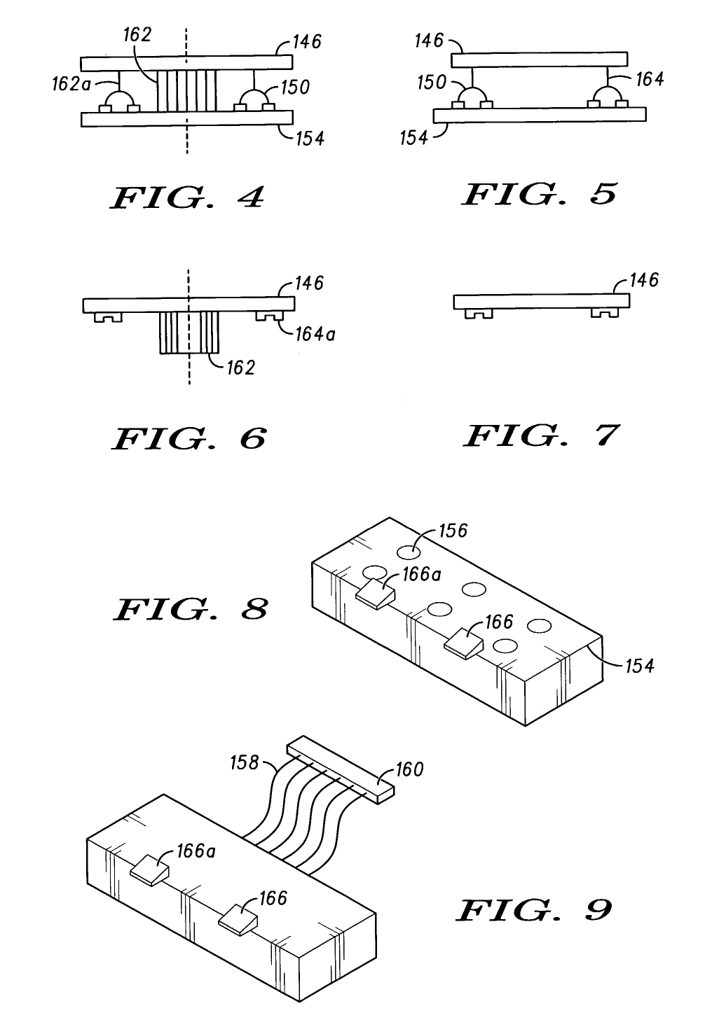

FIG. 3 illustrates an embodiment of the keyless input device 102 sized to be received within the receptacle 128. The keyless input device 102 includes a touchpad 146 for accepting input from the stylus 112, a human finger or any other pointing device. The touchpad 146 may be a semi-resistive touchpad or a capacitive touchpad for translating applied pressure into a readable electronic signal. A touchpad surface 148 may include a customer logo, name, or other graphical message to provide branding information for the consumer. The touchpad 146 may be directly integrated into the keyless input device 102 or may be mounted upon a plurality of dome switches 150, depending upon the desired functionality. FIGS. 4 and 5 illustrate sectional views of the combined touchpad 146 and dome switche 150 assembly, which allows the entire touchpad 146 to. It should be further understood that the dome switch 150 may be interchanged with any other suitable device having a contact and a non-contact position. The pivot motion occurs when a force F is applied to one of the switches 150 thereby causing the keyless input device 102 to shift as shown by the arrow 152.

The keyless input device 102 may further include a base 154, fixedly attached to the dome switches 150, having an electrical circuit (not shown) and a plurality of electrical contacts 156 (see FIG. 8). The electrical circuit and contacts 156 communicatively couple the dome switches 150 with the processor (not shown) controlling the device 100. FIG. 9 illustrates an another embodiment of the keyless input device 102 wherein the electrical contact is a flexible circuit 158 including a multi-pin connector 160. The flexible circuit 158 and connector 160 cooperate with a mating connector (not shown) on the wireless communications device 100 to communicatively couple the keyless input device 102 and the processor (not shown).

FIGS. 4 and 5 further illustrate alternate embodiments of the electrical connections between the touchpad 146 and the base 154. FIG. 4 illustrates an embodiment having a “bullseye” connector 162 constructed with a plurality of concentric rings for conducting individual electrical signals between the touchpad 146 and the base 154. The bullseye connector 162 additionally provides a central point or fulcrum, about which the touchpad 146 may pivot. The touchpad 146 may further be support or resisted by a spring or support generally indicated by the numeral 162a. FIG. 5 illustrates an embodiment wherein a conduit 164 integral to the dome switches 150 provides an electrical connection between the touchpad 146 and base 154. The pivot action is provided by deforming the dome switches 150 under a force F (as seen in FIG. 3).

FIGS. 6 and 7 illustrate alternate embodiments of the electrical and physical connections between the touch pad 146 and the device 100. In this embodiment, the base 154 is an integral component of the receptacle 128 or has been installed within the pocket 140 prior to the installation of the postponable keyless input device 102. FIG. 6 shows another embodiment of the bullseye connector of FIG. 4. The touchpad 146 includes a pair of connectors 164a sized to engage the conduit 164 or the supports 162a. FIG. 7 shows another embodiment of the switches 150 of FIG. 5. The touchpad 146 includes a pair of connectors 164a sized to electrically engage the conduit 164 and thereby provide a path through which electrical signals may be communicated.

The bullseye connector 162 of FIGS. 4 and 6 and the conduit 164 and dome switch 150 assembly of FIGS. 5 and 7 may be configured to provide multiple connections between the device 100 and the touchpad 146. The connections typically include a power line, a ground line and a pair of signal lines, although a person of ordinary skill in the art would know to increase or decrease the number of signal lines depending on the needs of a given application. The signal lines may be used, for example, by the touchpad 146 to provide the X and Y Cartesian coordinates corresponding to the point of contact of the stylus 112 or other point device on the surface of the touchpad 146. The communications connection is provided by multiplexing (or combining) the various signals into one or more signals. Multiplexing the signals may be accomplished by a variety of methods, for example a system using time-division multiplexing assigns each individual signal a small time interval in which to transmit. In this way, multiple signals may be transmitted, during their assigned time windows, and received by the appropriate components during that assigned window.

FIGS. 8 and 9 illustrate a pair of locking tabs 166 adapted to snap into a corresponding locking ridge formed into the wall 136 (see FIG. 2). The locking tab 166 includes a tapered edge to reduce the pressure necessary to snap the keyless input device 102 into the receptacle 128, and a flat surface 166a to hold the device in position. Moreover, a space may be provided on the end face 126, proximate to the connector 124 to allow a removal tool (not shown) to dislodge the keyless input device 102 from the receptacle 128.

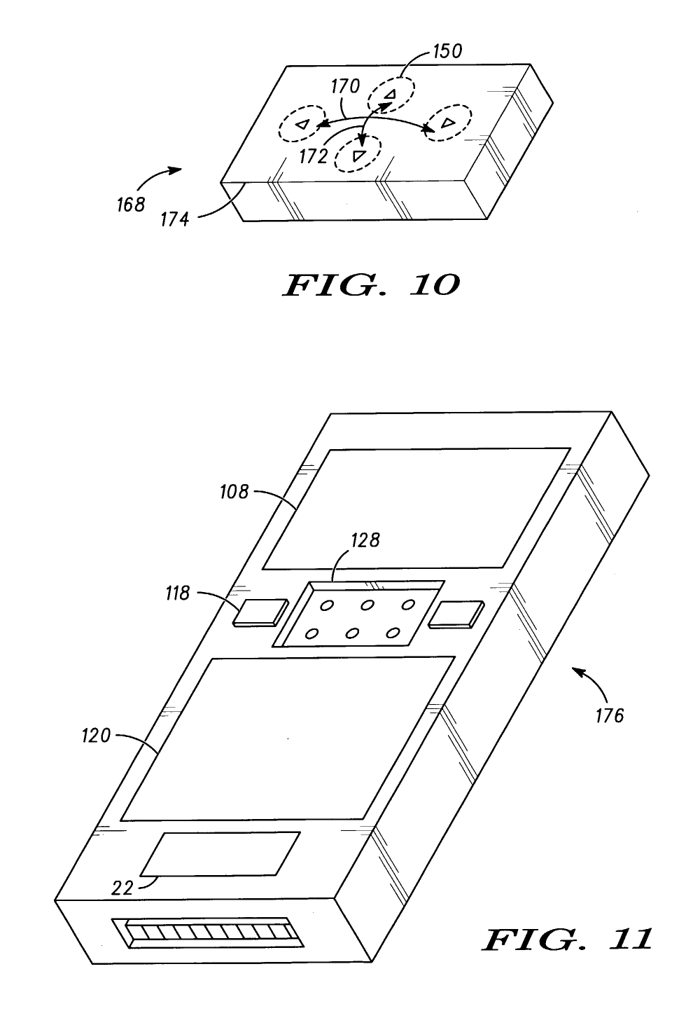

FIG. 10 illustrates an embodiment of the keyless input device 168 including two pairs of dome switches 150 arranged to provide a lateral and vertical pivoting motion, as indicated by the arrows 170 and 172, respectively. The touchpad 174 is configured to provide a writing surface to facilitate text input and allow a user to control information, such as a cursor, presented on the display 108.

FIG. 11 illustrates an embodiment of a wireless communications device 176 wherein the space reserved for the navigation key 116 now includes the receptacle 128, previously described in FIG. 2. The keyless input device 102 or 168 may be used to provide a wireless communication device 100 with a touchpad for text entry and a pivot for navigation while preserving the form and functionality of existing devices.

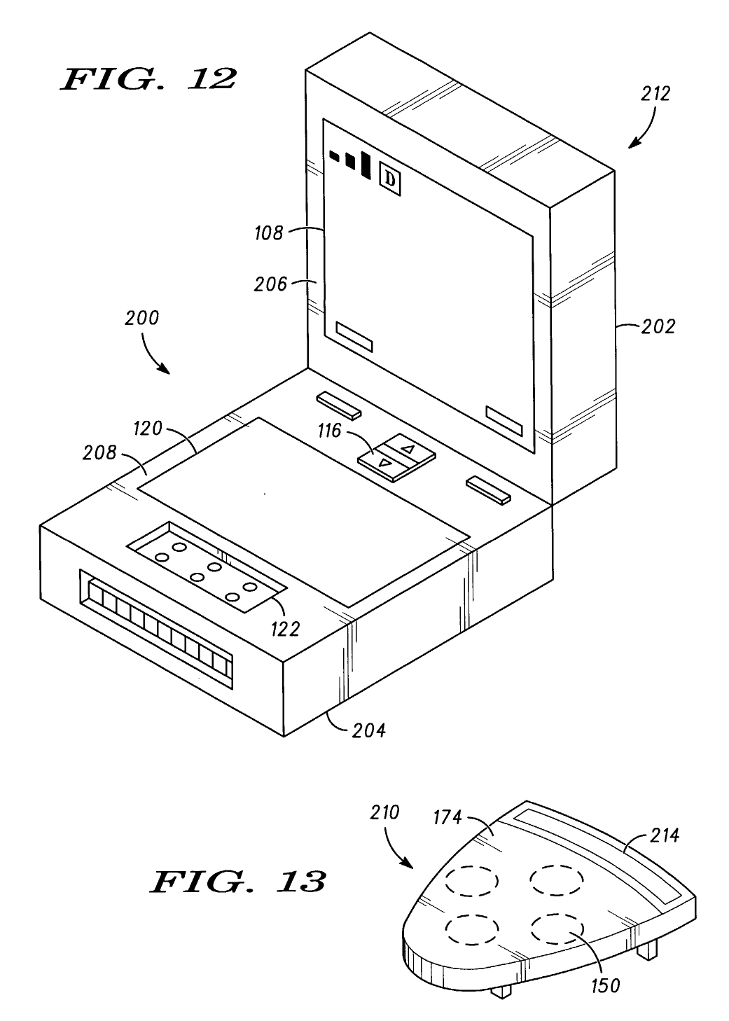

FIG. 12. illustrates an embodiment of a wireless communications device 200 configured as a two-piece design. The communications device includes a first body portion 202 and a second body portion 204 pivotably attached between an open and a closed position. The open position exposing a first and second interior surfaces 206, 208 including the display 108 positioned on the first surface 206 and a keypad 120 positioned on the second surface 208. The second surface may include a receptacle 128 in the space reserved for the navigation key 116 or the post-ponable badge 22. In this manner, the form and size of the device can remain constant, while providing a two-piece design configured to include a receptacle 128 on the second surface 208.

The wireless communication device 200 may further be configured to include the keyless input device 146 or 174 secured to an outer surface 212. FIG. 13 illustrates a keyless input device 210, including a touchpad 146, 172 and dome switches 150, integrated with an auxiliary display 214 to allow the user to manipulate information when the device is in the closed position.

Operation of the keyless input device 102 and 168 may be software controlled by the processor onboard the wireless communication device 100. The software may selectively activate and deactivate the touchpad 146 or 174 writing surface and dome switches 150 based on the options available to the user. For example, when in standby mode the touchpad 146 or 174 may be deactivated to prevent unwanted text entry, and the dome switches 150 may be active to allow the user to access additional options. Moreover, when the user is prompted to enter text, the dome switches 150 may be deactivated to prevent unwanted cursor movement.

Those skilled in the art will appreciate that, although the teachings of the embodied device have been illustrated herein, there is no intent to limit the invention to a particular embodiment. On the contrary, the intention of this application is to cover all modifications and embodiments fairly falling within the scope of the appended claims either literally or under the doctrine of equivalents.

What is claimed is:

1. A handheld electronics device comprising:
a housing;
an accessory pocket disposed within the housing; and
a keyless input device installable within the accessory pocket.

2. The handheld electronics device of claim 1 wherein the keyless input device further includes a touch-sensitive pad.

3. The handheld electronics device of claim 1 wherein the keyless input device includes a touch-sensitive pad and at least two switches.

4. The handheld electronics device of claim 1 wherein the keyless input device includes a fulcrum connection between a touch-sensitive pad and the device to provide for electrical communication with a processor.

5. The handheld electronics device of claim 3 wherein the at least two switches provide a conduit for a multiplexed signal.

6. The handheld electronics device of claim 5 wherein the at least two switches are pivotable and in electrical communication with a processor through a plurality of contact points on a circuit board.

7. The handheld electronics device of claim 1 wherein the keyless input device includes a plurality of integral locks adapted to removably secure the keyless input device to the housing.

8. The handheld electronics device of claim 1 wherein the keyless input device includes a graphical message.

9. The handheld electronics device of claim 1 wherein the graphical message is a logo.

10. The handheld electronics device of claim 1 wherein the device is a cellular phone, personal digital assistant, or pager.

11. The handheld electronics device of claim 1 wherein the keyless input includes a flexible connector to provide for electrical communications between the keyless input device and a processor.

12. A keyless input device comprising:
a touch-sensitive pad;
a communications conduit between the touchpad and a device;
a plurality of switches coupled to the touchpad, wherein the touchpad is removably mounted within the device.

13. The keyless input device of claim 12 wherein the keyless input device cooperates with a device user interface including a contextual software package to selectively engage and disengage the touch-sensitive pad and the plurality of switches.

14. The keyless input device of claim 12 wherein the touch-sensitive pad is pivotable about a central point.

15. The keyless input device of claim 12 wherein the touch-sensitive pad includes a user surface displaying a logo.

16. The keyless input device of claim 12 wherein the plurality of switches are dome switches.

17. The keyless input device of claim 12 further including a snap-in retainer for postponable installation and replacement.

18. A method of assembling a wireless communications device comprising:
forming an accessory pocket within a device housing; and
providing a touchpad; and
providing a plurality of switches removably coupled to the touchpad and fixedly attached within the accessory pocket.

19. The method of claim 24 further including the step of:
multiplexing a signal through the plurality of switches to provide electrical communications between the touchpad and the device.

20. The method of claim 23 wherein the step of providing the touchpad further includes displaying a graphical message on a user surface of the touchpad.
